(19) United States
(12) Patent Application Publication
(10) Pub. No.: US 2006/0293451 A1
(43) Pub. Date: Dec. 28, 2006

(54) Monomer-polymer systems with a controllable pot life

(75) Inventors: Gerold Schmitt, DARMSTADT (DE); Thomas Sufke, Erzhausen (DE); Volker Kerscher, Reinheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, DARMSTADT (DE)

(21) Appl. No.: 10/564,355

(22) PCT Filed: May 28, 2004
(86) PCT No.: PCT/EP04/05763

§ 371 Date: Jan. 12, 2006

(30) Foreign Application Priority Data
Aug. 25, 2003 (DE) 103 39 329.3

(51) Int. Cl. C08F 8/00

(52) U.S. Cl. 525/191

(57) ABSTRACT

The invention relates to a dual component system with a controllable pot life. Said system can be hardened by a redox initiator system and comprises an emulsion polymer or a plurality of emulsion polymers and an ethylenically unsaturated monomer or a monomer mixture made from ethylenically unsaturated monomers. The emulsion polymer as well as the monomer or the monomer mixture can contain one of the components of a redox initiator system. Pot life is controlled by absorption of the redox initiator system on the polymer (A and B).

### 1. TECHNICAL FIELD

The invention describes a two-component system with controllable pot life, curing via a redox initiator system and composed of an emulsion polymer or of more than one emulsion polymer and of an ethylenically unsaturated monomer or of a monomer mixture composed of ethylenically unsaturated monomers, where both the emulsion polymer and the monomer or the monomer mixture can comprise one of the components of a redox initiator system.

### 2. PRIOR ART

Two-component systems which cure via redox initiation and are based on monomers capable of free-radical polymerization have been known for a long time. The procedure is generally to take a liquid monomer or monomer mixture which can comprise a redox component and, prior to use, add to this the missing redox system components, or, respectively, all of the redox system components.

The systems described are those which also comprise a polymer dissolved in the monomer or monomer mixture. Other systems known especially from dental applications are those in which liquid monomer, a bead polymer, and a redox initiator system are mixed, prior to use, to give a high-viscosity composition.

DE 43 15 788 (Degussa AG) describes an ampoule which comprises a hardenable binder. The binder is composed of a polymer, of a reactive diluent, and of an initiator. The location of the initiator is within a glass ampoule, and when the plug is secured in the drilled hole the glass ampoule with the initiator is broken and the binder hardens and anchors the plug in the drilled hole.

DE-A 1 544 924 describes a process for production of a dental repair material for repair of prostheses by mixing a bead polymer composed mainly of methacrylic ester, such as methyl methacrylate and ethyl acrylate (92:8) with monomers, for example 95 parts of methyl methacrylate and 5 parts of methacrylic acid, or 85 parts of methyl methacrylate, 10 parts of oxypropyl methacrylate and 5 parts of methacrylic acid, and adding redox initiator. The pot lives achieved are from 4 to 5 minutes.

DE 27 10 548 describes a storage-stable curable composition composed of monomers, of oligomers and of polymeric compounds, and also of one or more components serving for curing. One or both of the components mentioned have been surrounded with a reaction-inhibiting protective envelope. The microcapsules have to be chemically inert with respect to the inner and outer phase, diffusion-resistant, and also fracture-resistant, elastic and heat-resistant. The curable composition moreover comprises a protective-envelope disintegrant and, if appropriate, also comprises additives. The protective-envelope disintegrants are entirely or to some extent composed of hollow microbeads which are not broken by forces usually exerted on the composition. For curing, in contrast, forces are applied which at least to some extent break the protective envelopes by virtue of the resultant grinding and frictional effect of the stable hollow microbeads.

A disadvantage common to all of these systems is that once the components have been mixed together there is limited time available (pot life) for operations, or that energy, for example in the form of grinding and frictional forces, has to be introduced during application. Although pot life can be prolonged to a certain extent via reduction of the concentration of redox components, this procedure is subject to limits because as concentration of redox components falls there is an adverse effect on hardening. Another disadvantage of the prior-art formulations is that the maximum permissible workplace concentrations (MPC) of volatile monomers, such as methyl methacrylate, can be exceeded. Use of less-volatile monomers has only limited effectiveness in countering this application-related disadvantage, because the bead polymers described above are not solvated sufficiently quickly by the less-volatile monomers. Furthermore, oxygen inhibition of the polymerization reaction is more pronounced when less-volatile monomers are used than when methyl methacrylate is used.

DE 100 51 762 provides monomer-polymer systems based on aqueous dispersions, having not only good mechanical properties but also the advantage of emitting no, or only a very small quantity of, monomers and moreover being easy to handle and having high storage stability. To this end, mixtures of aqueous dispersions are used whose particles have been solvated with an ethylenically unsaturated monomer which always comprises one of the redox components. These solvated aqueous systems have practically unlimited storage stability and do not cure until the water has been vaporized and a film has subsequently formed. The disadvantage of these systems is that, in particular in the case of relatively thick layers, the required vaporization of the water prolongs the hardening process and relatively large proportions of water cause difficulties with many applications, such as reactive adhesives.

WO 99/15592 describes reactive plastisols which after thermal gelling and hardening give films with good mechanical properties. These plastisols are composed of a known base polymer, preferably in the form of a spray-dried emulsion polymer, of a reactive monomer content, composed of at least one monofunctional (meth)acrylate monomer, of a plasticizer, and also, if appropriate, of other crosslinking monomers, of fillers, of pigments, and of auxiliaries. The base polymer can have a core/shell structure and comprise from 0 to 20% of polar comonomers. The plastisols are storage-stable for some weeks and have to be heated to high temperatures (e.g. 130° C.) for filming.

### 3. OBJECT

It was an object of the invention to provide room-temperature-curing systems whose pot life can be adjusted within wide limits and which nevertheless harden completely and rapidly, e.g. within 100 min, preferably within less than 50 min, at a defined juncture without energy input. The use of aqueous polymer dispersions is moreover to be avoided because the hardening process is too prolonged and the water causes problems in some applications. Use of an aqueous polymerization process is permitted if the content of added water is so very small that it does not cause problems in the application, e.g. if no film-formation is requited. The object also consisted in achieving complete hardening without air exclusion, even in thin layers. Another object to be achieved according to the invention consisted in minimizing undesirable odor and keeping the concentration of monomer in air below the MPC values applicable to the respective monomer.

### 4. ACHIEVEMENT OF OBJECT

The object of the invention is achieved via a system composed of the following components:

Component A
from 0.8 to 70% by weight, based on the entirety of polymers and monomers (component A and component B), of a polymer or polymer mixture prepared via aqueous emulsion polymerization and comprising from 0.01 to 30% by weight of a component, based on the entirety of components A and B of a redox initiator system mainly absorbed in the polymer particles or on the polymer particles,

Component B
from 30 to 99% by weight, based on the entirety of polymers and monomers (A and B), of at least one ethylenically unsaturated monomer,

Component C
from 0.01 to 5% by weight, based on the entirety of polymers and monomers (A and B), of at least one component of a redox initiator system which forms the partner of the initiator component absorbed in the particles of A, and

Component D
from 0 to 800% by weight, based on the entirety of polymers and monomers (A and B), of fillers, pigments, and other auxiliaries.

In another embodiment of the invention, the redox components are present separately in two or more emulsion polymers (component A and component A′, and if appropriate A″), which are suspended, prior to use, in an ethylenically unsaturated monomer or in a monomer mixture. Components A and A′ and, if appropriate, A″ can have identical or different structure, but are always within the general definition of A.

### 5. DESCRIPTION OF THE INVENTION

Prior to use, the preferably spray-dried emulsion polymer with absorbed initiator component is suspended, together with components D, in a monomer or in a monomer mixture which comprises the second and, if appropriate, third initiator component of the redox system. The suspended polymer is solvated, the absorbed initiator component is liberated, and the polymerization reaction is thus initiated. From the results of experiments it can be concluded that at least a considerable portion of the initiator component has entered the particles as part of a swelling process, because the polymerization reaction does not start until salvation has occurred.

It is probably not necessary that the entire initiator component is in absorbed form within the particle. It is important that the portion available outside the particle is so small as not to be capable of initiating a rapid polymerization reaction. It is important that most of the polymerization reaction does not proceed until the particles have been solvated.

Component A: The Emulsion Polymer

Component A is composed of the following monomers:
a) from 5 to 100% by weight of monofunctibnal (meth)acrylate monomers whose water-solubility is <2% by weight at 20° C.,
b) from 0 to 70% by weight of monomers copolymerizable with the (meth)acrylate monomer,
c) from 0 to 5% by weight of a polyunsaturated compound, and
d) from 0 to 20% by weight of a polar monomer whose water-solubility is >2% by weight at 20° C.

The emulsion polymer is in essence composed of methacrylate and acrylate monomers, and also of styrene and/or of styrene derivatives.

A preferred structure is composed of 90% of methacrylate and acrylate monomers, and a particularly preferred structure is composed exclusively of methacrylate and acrylate monomers.

Component A a)

Examples of monofunctional methacrylate and acrylate monomers whose water-solubility is <2% by weight at 20° C. are methyl (meth)acrylate, ethyl(meth)acrylate, propyl(meth)acrylate, isopropyl(meth)acrylate, butyl(meth)acrylate, isobutyl(meth)acrylate, hexyl(meth)acrylate, ethylhexyl(meth)acrylate, cyclohexyl(meth)acrylate, tetrahydrofuryl(meth)acrylate, isobornyl(meth)acrylate, benzyl(meth)acrylate, phenyl(meth)acrylate, phenylethyl(meth)acrylate, 3,3,5-tri-methylcyclohexyl(meth)acrylate. Methods for determination of water-solubility of organic compounds are known to the person skilled in the art.

In order to achieve a high glass transition temperature it is preferable to incorporate methacrylate monomers, in particular methyl methacrylate, and in order to lower the glass transition temperature it is preferable to incorporate methacrylates having a carbon number >4 in the side chain and acrylates. The monomers are advantageously combined in such a way as to give a glass transition temperature above 60° C., preferably above 80° C. and in particular above 100° C. The glass transition temperatures are measured to EN ISO 11357.

Given a known glass transition temperature for the homopolymers, the glass transition temperatures of the copolymers can be calculated by the following formula of Fox:

$$\frac{1}{{T}_{g}} = \frac{{W}_{A}}{{T}_{gA}} + \frac{{W}_{B}}{{T}_{gB}} + \frac{{W}_{C}}{{T}_{gC}} + ⋯$$

where T_{g} is the glass transition temperature of the copolymer (in K), T_{gA}, T_{gB}, T_{gC} etc. are the glass transition temperatures of the homopolymers of the monomers A, B, C, etc. (in K). W_{A}, W_{B}, W_{C} etc. are the contents by weight of the monomers A, B, C, etc. within the polymer.

The higher the glass transition temperature of the polymer, the greater the resistance to salvation, and therefore the greater the pot life with respect to the monomers added prior to use. Rising molecular weight also increases resistance to solvation.

Component A b)

Other monomers that can be used are vinyl acetate, and also styrene and/or styrene derivatives.

Examples of styrene derivatives are α-methylstyrene, chlorostyrene, or p-methylstyrene.

Component A d)

Resistance to solvation can also be controlled via incorporation of polar monomers, such as methacrylamide or methacrylic acid, into the emulsion polymer. It rises with an increasing amount of methacrylamide or methacrylic acid.

Examples of other polar monomers are acrylic acid, acrylamide, acrylonitrile, methacrylonitrile, itaconic acid, maleic acid, or N-methacryloyloxyethylethylene-urea. It is also possible to use N-methylolacrylamide or -methacrylamide as long as their content is limited in such a way as not to bring about any pronounced crosslinking of the dispersion particles.

The content of N-methylolacrylamide or -methacrylamide should, if at all possible, not exceed 5% by weight, based on component A. Content below 2% by weight is preferred and 0% by weight is particularly preferred.

Pronounced crosslinking would limit the swelling of the particles in the formulation and therefore limit homogenization. The content of the polar monomers depends primarily on the desired pot life of the formulation, but is also affected by the glass transition temperature of the polymer. The lower the glass transition temperature, the higher the content needed of polar monomers in order to achieve a particular resistance to salvation. Furthermore, the content of polar monomers has to be matched to the solvent power of the monomers used in the formulation.

The content of polar monomers is generally in the range from 0 to 20%, preferably from 1 to 10%, particularly preferably from 2 to 10%, in particular from 3 to 10%, based on component A.

Methacrylamide and acrylamide, and also methacrylic acid and acrylic acid, are particularly effective and are therefore preferred. Particular preference is given to a combination composed of methacrylamide or acrylamide with methacrylic acid or acrylic acid in ratios by weight of 3:1 to 1:3.

Component A c)

Incorporation of relatively high contents of polyunsaturated monomers (crosslinking agents) limits the achievable degree of swelling in the formulation and can lead to polymer having nanoscale inhomogeneity. This is not necessarily disadvantageous in all cases, but is preferably not desired. Content of polyunsaturated monomers is therefore limited to 5%, based on component A, preferably being below 2%, in particular below 0.5%.

It is particularly preferable to use no polyunsaturated monomers as comonomers.

Examples of polyunsaturated monomers are ethylene glycol di(meth)acrylate, and also diethylene glycol di(meth)acrylate, triethylene glycol di(meth)acrylate and higher homologs thereof, 1,3- and 1,4-butanediol di(meth)acrylate, 1,6-hexanediol di(meth)acrylate, trimethylolpropane di(meth)acrylate, triallyl cyanurate, or allyl (meth)acrylate.

The structure of the emulsion polymer can also be that of a core-shell polymer. In one embodiment, the polar monomers are limited to the shell, but in other respects the structure of core and shell are identical. In another embodiment, core and shell can differ in their monomer constitution. In this case it is advantageous for the glass transition temperature of the shell to be above that of the core. In this embodiment, it is also possible that the polar monomers have been limited to the shell. The ratio by weight of core to shell is from 1:99 to 99:1, i.e. is generally non-critical.

The person skilled in the art will generally select the relatively complex core-shell structure only if advantageous properties can be brought about thereby. A core with a low glass transition temperature will generally be selected, e.g. in order to render the hardened films more flexible. In these instances, the shell with relatively high glass transition temperature has the function of providing the resistance to salvation. To this end, the shell content should be sufficiently high, e.g. 20%, based on component A, or higher. On the other hand, if the core content is too low it is impossible to exert the substantial influence on film properties. The person skilled in the art will advantageously select the core content above 30%, more advantageously above 50%.

The emulsion polymerization reaction is carried out in a manner known to the person skilled in the art. By way of example, EP 0376096 B1 describes the conduct of an emulsion polymerization reaction.

The emulsion polymer comprises a component of a redox initiator system, i.e. either a peroxide or the accelerator component.

In order to introduce a component of the redox initiator system into the dispersion particles, it is added during preparation of the emulsion, i.e. emulsified together with water, with monomers, with emulsifiers, and, if appropriate, with other components. The component of the redox initiator system is therefore fed together with the emulsion to the reaction vessel. Another possibility of introducing a component of the redox initiator system into the dispersion particles consists in adding this, if appropriate dissolved in a monomer or in an inert solvent, to the dispersion subsequently, and permitting it to enter the dispersion particles as part of a swelling process.

Another possible variant consists in absorbing initiator component and accelerator component within different spray-dried emulsion polymers and then suspending these in a monomer or monomer mixture. The polymerization reaction begins when both of the polymer beads have been solvated and therefore the initiator components are liberated. It is not generally of any critical importance here whether the emulsion polymers have identical or different constitution. Different constitution could have the disadvantage in particular cases of giving clouded polymers as a result of incompatibility, and this could be undesirable for certain applications.

The solid can be obtained from the dispersion via known processes. Among these are spray drying, freeze coagulation with suction filtration and drying, and also isolation via compression by means of an extruder. The polymer is preferably obtained via spray drying.

The molar mass of component A is from 10 000 g/mol to 5 000 000 g/mol, preferably from 50 000 g/mol to 1 000 000 g/mol, and very particularly preferably from 100 000 g/mol to 500 000 g/mol. The molar mass is determined by means of gel permeation chromatography.

Resistance to solvation can also be adjusted via selection of particle size.

The primary particle size of component A is from 50 nm to 2 micrometers, preferably from 100 nm to 600 nm, and very particularly preferably from 150 nm to 400 nm. Particle size is measured with a Coulter N4 MD Sub-Micron Particle Analyzer.

Component B: The Monomers

The pot life of the formulation composed of components A, B, C and D can be influenced via the solvating power of the monomers used in component B. Whereas methyl(meth)acrylate has high solvating power and therefore leads to relatively low pot lives, monomers having greater hydrophobic character, e.g. 1,4-butanediol di(meth)acrylate, and monomers having high molecular weight, e.g. 2-[2-(2-ethoxyethoxy)ethoxy]ethyl(meth)-acrylate, generally increase pot life.

Monomers which can be used are in principle any of the methacrylate and acrylate monomers and styrene, and also mixtures of these. Subordinate contents of other monomers can be used as long as this does not cause problems with the copolymerization reaction, but are not preferred, examples being vinyl acetate, maleic acid, fumaric acid, and their anhydrides or esters. Criteria for selection of the monomers are their solvent power, vapor pressure, toxicological properties, and odor. Examples of (meth)acrylates are methyl(meth)acrylate, ethyl(meth)acrylate, propyl(meth)acrylate, isopropyl(meth)acrylate, butyl(meth)acrylate, isobutyl(meth)acrylate, hexyl(meth)acrylate, ethyihexyl(meth) acrylate, cyclohexyl(meth)acrylate, tetrahydrofuryl(meth)acrylate, isobornyl(meth)acrylate, benzyl(meth)acrylate, phenyl(meth)acrylate, phenylethyl(meth)acrylate, 3,3,5-tri-methylcyclohexyl(meth)acrylate, ethylene glycol di(meth)acrylate, and also diethylene glycol di(meth)acrylate, triethylene glycol di(meth)acrylate, and higher homologs of these, 1,3- and 1,4-butanediol di(meth)acrylate, 1,6-hexanediol di(meth)acrylate, 1,12-dodecanediol di(meth)acrylate, glycerol di(meth)acrylate, trimethylolpropane tri(meth)acrylate, trimethylolpropane di(meth)acrylate, and allyl(meth)acrylate.

Preference is given to (meth)acrylates whose molar mass is above 140 g/mol, particularly preferably above 165 g/mol, and in particular above 200 g/mol.

Methacrylates are preferred over acrylates for reasons of toxicology. The monomer mixture can also comprise subordinate amounts, i.e. up to 30%, preferably up to 10%, and particularly preferably up to 5%, of functional monomers, such as hydroxyethyl(meth)acrylate, hydroxypropyl(meth)acrylate, (meth)acrylic acid, mono-2-methacryloyloxyethyl maleate, or mono-2-methacryloyloxyethyl succinate.

Another advantage of monomers with high molecular weight, alongside high pot lives due to very low solvation rate, is lower levels of emissions.

Component C: The Redox System

The redox system is composed by way of example of a peroxide and of an accelerator component.

Examples of peroxides that can be used are dibenzoyl peroxide and dilauryl peroxide.

An accelerator component that can be used is amines, such as N,N-dimethyl-p-toluidine, N,N-bis(2-hydroxy-ethyl)-p-toluidine, or N,N-bis(2-hydroxypropyl)-p-toluidine. m-Toluidine derivatives and xylidine derivatives may be used correspondingly.

Other redox initiator systems that can be used, besides the abovementioned peroxide/amine systems, are systems composed of hydroperoxides and of vanadium activators.

Examples of hydroperoxides that can be used are tert-butyl hydroperoxide, cumene hydroperoxide, and ketone peroxides. Examples of ketone peroxides that can be used are methyl ethyl ketone peroxide, methyl isobutyl ketone peroxide, or cyclohexanone peroxide, individually or in a mixture. Vanadium activators that can be used are acidic vanadium phosphates in combination with coactivators, such as lactic acid.

This list of redox systems is non-limiting, and other redox systems can of course also be used, examples being other metal compounds, etc.

Component D:

The formulation can comprise, alongside the components described, conventional particulate fillers, e.g. titanium dioxide, carbon black or silicon dioxide, glass, glass beads, glass powder, quartz sand, powdered quartz, other types of sand, corundum, clay products, clinker, baryte, magnesia, calcium carbonate, powdered marble, or aluminum hydroxide, or mineral or organic pigments and auxiliaries.

Examples of auxiliaries can be: plasticizers, flow aids, thickeners, antifoams, adhesives, or wetting agents. It is preferable that no plasticizer is present.

The grain diameter of the particulate fillers is usually from about 0.001 mm to about 6 mm.

It is usual to use from 0 to 8 parts by weight of fillers for each part by weight of polymer.

The Mixing Ratio

The mixing ratio of the components used always has to be selected in such a way as to achieve complete polymerization of the given system. To this end, in particular there has to be a sufficient amount available of a redox initiator system, at least one component of the redox initiator system being made available by way of the amount used of component A. The mixing ratio also depends on the desired application. This determines the amount used of components A-D.

The polymer content (component A) can be from 0.8 to 70% by weight, and can itself in turn comprise from 0.05 to 30% by weight of a component of a redox initiator system. The content of an ethylenically unsaturated monomer (component B) can be from 30 to 99% by weight. The mixture further comprises from 0.01 to 5% by weight of at least one component of a redox system which is the partner of the initiator components absorbed within components A. However, it is also possible that this component, too, has been absorbed within polymer particles prior to its use. The mixture can further comprise from 0 to 800% by weight of fillers, pigments, and other auxiliaries.

Applications

The system is suitable for adhesives, casting resins, floor coatings, sealing compositions, reactive plugs, dental composition, and similar applications.

### EXAMPLES

In an application as casting resin, high polymer content (component A) is preferred. This should be in the range from 40 to 70% by weight. The content of the redox component in component A is from 0.01 to 5% by weight, based on component A. With this, the content of an ethylenically unsaturated monomer (component B) is from 58.8 to 30% by weight. The content of component C is from 0.01 to 5% by weight.

In the field of highly crosslinked systems, it can be useful to limit the content of polymer (component A) and to use it merely as carrier for a redox initiator component. The content of component A is therefore correspondingly very small and is preferably from 1 to 10% by weight. The content of the redox component absorbed within component A is correspondingly high and can be up to 10% by weight or even up to 30% by weight, based on component A. The content of the ethylenically unsaturated monomer (component B) is therefore from 98.8 to 90% by weight. The content of component C is from 0.01 to 5% by weight.

Preparation of the Emulsion Polymers

All of the emulsion polymers were prepared by the feed process.

The initial charge was stirred at 80° C. for 5 min in the reaction vessel. The remaining feed 1 was then added over a period of 3 h and feed 2 was added over a period of 1 h. Feeds 1 and 2 were emulsified prior to addition to the reaction mixture.

The resultant dispersion was then spray-dried.

The mixtures are listed in table 1.

TABLE 1

| | Initial charge | Feed 1 | Feed 2 | Characterization |
|---|---|---|---|---|
| Polymer 2 | 1280 g water, | 1920 g water, | 640 g water, | r_{NS}: 188 nm, r_{NS} core = 167 nm, |
| | 0.384 g Marlon PS60, | 9.6 g Marlon PS60, | 3.2 g Marlon PS60, | average particle size, equipment: |
| | 0.192 g NaPS | 2.4 g NaPS | 2.4 g Trigonox A-W70 | Coulter N4 MD Sub-Micron Particle |
| | | 1920 g MMA | 627.2 g MMA | Analyzer |
| | | | 12.8 g MAA | 684 ppm tert-butyl hydroperoxide |
| | | | | (added subsequently) |
| | | | | S. C.: 39.8% |
| Polymer 3 | 1280 g water, | 1920 g water, | 640 g water, | r_{NS}: 160 nm, r_{NS} core = 138 nm |
| | 0.384 g Marlon PS60, | 9.6 g Marlon PS60, | 3.2 g Marlon PS60, | 710 ppm tert-butyl hydroperoxide |
| | 0.192 g NaPS | 2.4 g NaPS, | 2.4 g Trigonox A-W70, | (added subsequently) |
| | | 1920 g MMA | 608 g MMA, | S. C.: 38.9% |
| | | | 32 g MAA | |
| Polymer 4 | 1280 g water, | 1920 g water, | 640 g water, | r_{NS}: 208 nm, r_{NS} core = 181 nm |
| | 0.384 g Marlon PS60, | 9.6 g Marlon PS60, | 3.2 g Marlon PS60, | 710 ppm tert-butyl hydroperoxide |
| | 0.192 g NaPS | 2.4 g NaPS, | 2.4 g Trigonox A-W70, | (added subsequently) |
| | | 1920 g MMA | 588.8 g MMA, | S. C.: 39.4% |
| | | | 51.2 g MAA | |
| Polymer 5 | 1280 g water, | 1280 g water, | 1280 g water, | r_{NS}: 156 nm, r_{NS} core = 127 nm |
| | 0.384 g Marlon PS60, | 6.4 g Marlon PS60, | 6.4 g Marlon PS60, | |
| | 0.192 g NaPS | 2.4 g NaPS, | 2.4 g Trigonox A-W70, | |
| | | 1280 g MMA | 1280 g MMA, | |
| Polymer f | 1280 g water, | 1280 g water, | 1280 g water, | r_{NS}: 163 nm, r_{NS} core = 133 nm |
| | 0.384 g Marlon PS60, | 6.4 g Marlon PS60, | 6.4 g Marlon PS60, | S. C.: 39.9% |
| | 0.192 g NaPS | 2.4 g NaPS, | 2.4 g Trigonox A-W70, | |
| | | 1280 g MMA | 1254.4 g MMA, | |
| | | | 25.6 g MA | |
| Polymer 6 | 1280 g water, | 1280 g water, | 1280 g water, | r_{NS}: 158 nm, r_{NS} core = 129 nm |
| | 0.384 g Marlon PS60, | 6.4 g Marlon PS60, | 6.4 g Marlon PS60, | |
| | 0.192 g NaPS | 2.4 g NaPS, | 2.4 g Trigonox A-W70, | |
| | | 1280 g MMA | 1216.0 g MMA, | |
| | | | 64.0 g MA | |
| Polymer 7 | 1260 g water, | 1280 g water, | 1280 g water, | r_{NS}: 180 nm, r_{NS} core = 144 nm |
| | 0.384 g Marlon PS60, | 6.4 g Marlon PS60, | 6.4 g Marlon PS60, | S. C.: 40.1% |
| | 0.192 g NaPS | 2.4 g NaPS, | 2.4 g Trigonox A-W70, | |
| | | 1280 g MMA | 1152.0 g MMA, | |
| | | | 128.0 g MA | |
| Polymer 8 | 1280 g water, | 1280 g water, | 1280 g water, | r_{NS}: 195 nm, r_{NS} core = 145 nm |
| | 0.384 g Marlon PS60, | 6.4 g Marlon PS60, | 6.4 g Marlon PS60, | S. C.: 40.5% |
| | 0.192 g NaPS | 2.4 g NaPS, | 2.4 g Trigonox A-W70, | |
| | | 1280 g MMA | 1254.4 g MMA, | |
| | | | 25.6 g MAA | |
| Polymer 9 | 1280 g water, . | 1280 g water, | 1280 g water, | r_{NS}: 160 nm, r_{NS} core = 124 nm |
| | 0.384 g Marlon PS60, | 6.4 g Marlon PS60, | 6.4 g Marlon PS60, | S. C.: 39.6% |
| | 0.192 g NaPS | 2.4 g NaPS, | 2.4 g Trigonox A-W70, | |
| | | 1280 g MMA | 1216.0 g MMA, | |
| | | | 64.0 g MAA | |
| Polymer 10 | 1280 g water, | 1280 g water, | 1280 g water, | r_{NS}: 151 nm, r_{NS} core = 116 nm |
| | 0.384 g Marlon PS60, | 6.4 g Marlon PS60, | 6.4 g Marlon PS60, | S. C.: 40.0% |
| | 0.192 g NaPS | 2.4 g NaPS, | 2.4 g Trigonox A-W70, | |
| | | 1280 g MMA | 1177.6 g MMA, | |
| | | | 102.4 g MAA | |
| Polymer 11 | 1280 g water, | 1280 g water, | 1280 g water, | r_{NS}: 184 nm, r_{NS} core = 145 nm |
| | 0.384 g Marlon PS60, | 6.4 g Marlon PS60, | 6.4 g Marlon PS60, | S. C.: 40.4% |
| | 0.192 g NaPS | 2.4 g NaPS, | 2.4 g Trigonox A-W70, | |
| | | 1280 g MMA | 1152.0 g MMA, | |
| | | | 64.0 g MAA | |
| | | | 64.0 g MA | |
| Polymer 12 | 1280 g water, | 1280 g water, | 1280 g water, | r_{NS}: 183 nm |
| | 0.384 g Marlon PS60, | 6.4 g Marlon PS60, | 6.4 g Marlon PS60, | S. C.: 39.3% |
| | 0.192 g NaPS | 2.4 g NaPS, | 2.4 g Trigonox A-W70, | |
| | | 1280 g MMA | 1216 g MMA, | |
| | | | 64 g MAA | |
| Polymer 13 | 1280 g water, | 1280 g water, | 1280 g water, | r_{NS}: 187 nm, |
| | 0.384 g Marlon PS60, | 6.4 g Marlon PS60, | 6.4 g Marlon PS60, | S. C.: 39.7% |
| | 0.192 g NaPS | 2.4 g NaPS, | 36.5 g Trigonox A-W70, | |
| | | 1280 g MMA | 1216 g MMA, | |
| | | | 64 g MAA | |
| Polymer 14 | 1240 g water, | 1280 g water, | 1280 g water, | r_{NS}: 187 nm, |
| | 0.384 g Marlon PS60, | 6.4 g Marlon PS60, | 6.4 g Marlon PS60, | S. C.: 39.5% |
| | 0.269 g 4,4′-azo- | 3.19 g 4,4′-azo- | 36.6 g Trigonox A-W70, | |
| | bis(4-cyanovalerian | bis(4-cyanovalerian | 1216 g MMA, | |
| | acid) | acid) | 64 g MAA | |
| | 0.143 g NaHCO₃ | 1.7 g NaHCO₃ | | |
| | | 1280 g MMA | | |
| Polymer 15 | 1280 g water, | 2560 g water, | 2.4 g Trigonox A-W70 | r_{NS}: 135 nm, |
| | 0.384 g Marlon PS60, | 12.78 g Marlon PS60, | | S. C.: 39.8% |
| | 0.192 g NaPS | 2.4 g NaPS, | | |
| | | 2496 g MMA | | |
| | | 64 g MAA | | |
| Polymer 16 | 1280 g water, | 2560 g water, | 2.4 g Trigonox A-W70 | r_{NS}: 165 nm, |
| | 0.384 g Marlon PS60, | 12.78 g Marlon PS60, | | S. C.: 39.6% |
| | 0.192 g NaPS | 2.4 g NaPS, | | |
| | | 2355.2 g MMA | | |
| | | 204.8 g MAA | | |
| Polymer 17 | 1280 g water, | 1280 g water, | 1280 g water, | r_{NS}: 186 nm, |
| | 0.384 g Marlon PS60, | 6.4 g Marlon PS60, | 6.4 g Marlon PS60, | S. C.: 39.5% |
| | 0.192 g NaPS | 2.4 g NaPS | 1216 g MMA | |
| | | 1280 g MMA | 64 g MAA | |
| | | | 25.6 g N,N-dimethyl-p- | |
| | | | toluidine | |

rₙₛ: radius of entire particle in nm
Abbreviations:
Marlon PS 60: emulsifier, producer: Sasol
NaPS sodium persulfate
Trigonox A-W70: encapsulated initiator, producer: Akzo Nobel
MMA: methyl methacrylate
MA: methacrylic acid
MAA: methacrylamide

Preparation of a Monomer-Polymer Mixture and Determination of Pot Life/Solvation Time

20 g (=40% by weight) of the respective polymer (component A) are used as initial charge in a beaker (0.2 l). 30 g (=60% by weight) of an ethylenically unsaturated monomer or of a monomer mixture (component B) are added and stirred with a wooden spatula until the mixture is regarded as no longer useful for operations. This time is stated as solvation time or pot life.

The results are listed in table 2. The experiments without hardening show how resistance to solvation can be increased via incorporation of polar monomers.

TABLE 2
Pot lives/solvation times/polymerization times

| | | | | | | dt [min] | | |
|---|---|---|---|---|---|---|---|---|
| | | | | | | between | | |
| | | | | | | solvation | | Polymeri- |
| | | | Monomer | Solvation | Poly time | time and | PT | zation |
| Polymer | | | component B | time [min] | [min] | poly time | [° C.]*) | method |
| | Constitution | | | | | | | |
| | ETMA: 2-(2-(2-ethoxyethoxy) ethoxy) ethyl | | | | | | | |
| | methacrylate | | | | | | | |
| | THFMA: tetrahydrofuryl methacrylate, | | | | | | | |
| | 1,4-BDDMA: 1,4-butanediol dimethacrylate | | | | | | | |
| 1 | 100% MMA | | | | | | | |
| | Core 75% | Shell 25% | | | | | | |
| | | | ETMA | 17 | | | | |
| | | | THFMA | 8 | | | | |
| 2 | 100% MMA | 98% MMA − 2% MAA + 0.0625% | ETMA | 21 | | | | |
| | | Trigonox A-W70 + 710 ppm | | | | | | |
| | | tert-butyl hydroperoxide | | | | | | |
| | | | THFMA | 11 | | | | |
| 3 | 100% MMA | 95% MMA − 5% MAA + 0.0625% | ETMA | 80 | | | | |
| | | Trigonox A-W70 + 710 ppm | | | | | | |
| | | tert-butyl hydroperoxide | | | | | | |
| | | | THFMA | 40 | | | | |
| 4 | 100% MMA | 92% MMA − 8% MAA + 0.0625% | ETMA | 207 | | | | |
| | | Trigonox A-W70 + 684 ppm | | | | | | |
| | | tert-butyl hydroperoxide | | | | | | |
| | | | THFMA | 107 | | | | |
| | Core 50% | Shell 50% | | | | | | |
| 5 | 100% MMA | 100% MMA + 0.0625% Trigonox | 1,4-BDDMA | 30 | | | | |
| | | A-W70 | | | | | | |
| | | | ETMA | 12 | | | | |
| 6 | 100% MMA | 98% MMA − 2% MA + 0.0625% | 1,4-BDDMA | 95 | | | | |
| | | Trigonox A-W70 | | | | | | |
| | | | ETMA | 16 | | | | |
| 7 | 100% MMA | 95% MMA − 5% MA + 0.0625% | 1,4-BDDMA | >240 | | | | |
| | | Trigonox A-W70 | | <960 | | | | |
| | | | ETMA | 24 | | | | |
| 8 | 100% MMA | 90% MMA − 10% MA + 0.0625% | 1,4-BDDMA | >1200 | | | | |
| | | Trigonox A-W70 | | | | | | |
| | | | ETMA | 29 | | | | |
| 9 | 100% MMA | 98% MMA − 2% MAA + 0.0625% | ETMA | 29 | | | | |
| | | Trigonox A-W70 | | | | | | |
| | | | THFMA | 9 | | | | |
| 10 | 100% MMA | 95% MMA − 5% MAA + 0.0625% | ETMA | 84 | | | | |
| | | Trigonox A-W70 | | | | | | |
| | | | THFMA | 36 | | | | |
| 11 | 100% MMA | 92% MMA − 8% MAA + 0.0625% | ETMA | 160 | | | | |
| | | Trigonox A-W70 | | | | | | |
| | | | THFMA | 80 | | | | |
| 12 | 100% MMA | 90% MMA − 5% MAA − 5% MA + | ETMA | 200 | | | | |
| | | 0.0625% Trigonox A-W70 | | | | | | |
| | | | THFMA | 100 | | | | |
| | Peroxide-encapsulated polymerization | | | | | | | |
| | reactions | | | | | | | |
| | Core 50% | Shell 50% | | | | | | |
| 13 | 100% MMMA | 95% MMA − 5 MAA + 0.0625% | ETMA | 92 | 170 | 78 | 41 | B |
| | | Trigonox AW70 | | | | | | |
| | | | THFMA | 49 | 79 | 30 | 87 | B |
| 14 | 100% MMA | 95% MMA − 5% MAA + 1.42% | ETMA | 56 | 75 | 18 | 55 | B |
| | | Trigonox AW70 | | | | | | |
| | | | THFMA | 51 | 38 | −13 | 85 | B |
| 15 | 100% MMA | 95% MMA − 5% MAA + 1.4% | THFMA | 62 | 138 | 76 | 79 | B |
| | | Trigonox AW70 | | | | | | |
| | Core 100% | | | | | | | |
| 16 | 97.5% MMA − | — | ETMA | 28 | 147 | 118 | 42 | B |
| | 2.5% MAA + | | | | | | | |
| | 0.0625% | | | | | | | |
| | Trigonox | | | | | | | |
| | A-W70 | | | | | | | |
| | | | THFMA | 14 | 53 | 39 | 86 | B |
| 17 | 92% MMA − 8% | | ETMA | 178 | 295 | 117 | 29 | B |
| | MAA + | | | | | | | |
| | 0.0625% | | | | | | | |
| | Trigonox | | | | | | | |
| | A-W70 | | | | | | | |
| | | | THFMA | 162 | 208 | 46 | 34 | B |
| | Amine-encapsulated polymerization | | | | | | | |
| | reactions | | | | | | | |
| | Core 50% | Shell 50% | | | | | | |
| 18 | 100% MMA | 95% MMA − 5% MAA + 1% N,N- | ETMA | 74 | 77 | 3 | 52 | A |
| | | dimethyl-p-toluidine | | | | | | |
| | | | ETMA + 2% MA | n.d. | 66 | | 63 | A |
| | | | ETMA/THFMA | n.d. | 67 | | 62 | A |
| | | | 80/20 | | | | | |
| | | | THFMA | 38 | 47 | 9 | 80 | A |
| | | | THFMA + 2% MA | 38 | 41 | 3 | 85 | A |

*)polymerization temperature peak maximum

Determination of Polymerization Times:

Polymerization time is defined as the time taken by mixture from the start of the polymerization reaction (addition of the initiators) to achievement of peak polymerization temperature. The results stated are the time taken and the peak temperature. The method of measurement used a contact thermometer, with temperature profile recording.

The results are listed in table 2.

All of the polymerization reactions were carried out with a mixing ratio the same as that described above for pot life determination.

Polymerization process A: means that 1.4% by weight of BP-50-FT technical-grade benzoyl peroxide (BP-50-FT being a white flowable powder, 50% by weight content of dibenzoyl peroxide, phlegmatized with a phthalate), based on monomer, i.e. component B (0.42 g for 30 g of monomer) are mixed with 20 g of polymer powder (component A). The second redox component, the corresponding amine, is absorbed in component A and supplied via addition of component A.

Polymerization process B: means that 0.3% by weight of VN-2 (vanadium compound, 0.2% V, solution in monobutyl phosphate)+0.5% by weight of lactic acid are dissolved in the monomer phase, i.e. component B (90 mg VN2+150 mg of lactic acid for 30 g of monomer). The missing redox component, the hydroperoxide, is supplied via addition of component A, in which it has been absorbed.

1. A composition comprising,
component A
from 0.8 to 70% by weight, based on the entirety of polymers and monomers (component A and component B), of a polymer or polymer mixture prepared via aqueous emulsion polymerization and comprising from 0.01 to 30% by weight of a component of a redox initiator system mainly absorbed in the polymer particles or on the polymer particles,
component B
from 30 to 99% by weight, based on the entirety of polymers and monomers (A and B), of at least one ethylenically unsaturated monomer,
component C
from 0.01 to 5% by weight, based on the entirety of polymers and monomers (A and B), of at least one component of a redox initiator system which forms the partner of the initiator component absorbed in the particles of A, and
component D
from 0 to 800% by weight, based on the entirety of polymers and monomers (A and B), of fillers, pigments, and other auxiliaries.

2. The composition as claimed in claim 1, comprising,
component A
from 3 to 60% by weight, based on the entirety of polymers and monomers (component A and component B), of a polymer or polymer mixture prepared via aqueous emulsion polymerization and comprising from 0.01 to 30% by weight of a component of a redox initiator system mainly absorbed in the polymer particles or on the polymer particles,
component B
from 40 to 97% by weight, based on the entirety of polymers and monomers (A and B), of at least one ethylenically unsaturated monomer,
component C
from 0.01 to 5% by weight, based on the entirety of polymers and monomers (A and B), of at least one component of a redox initiator system which forms the partner of the initiator component absorbed in the particles of A, and
component D
from 0 to 800% by weight, based on the entirety of polymers and monomers (A and B), of fillers, pigments, and other auxiliaries.

3. The composition as claimed in claim 1, comprising,
component A
from 5 to 60% by weight, based on the entirety of polymers and monomers (component A and component B), of a polymer or polymer mixture prepared via aqueous emulsion polymerization and comprising from 0.01 to 30% by weight of a component of a redox initiator system mainly absorbed in the polymer particles or on the polymer particles,
component B
from 40 to 95% by weight, based on the entirety of polymers and monomers (A and B), of at least one ethylenically unsaturated monomer,
component C
from 0.01 to 5% by weight, based on the entirety of polymers and monomers (A and B), of at least one component of a redox initiator system which forms the partner of the initiator component absorbed in the particles of A, and
component D
from 0 to 800% by weight, based on the entirety of polymers and monomers (A and B), of fillers, pigments, and other auxiliaries.

4. The composition as claimed in claim 1, comprising,
component A
from 10 to 50% by weight, based on the entirety of polymers and monomers (component A and component B), of a polymer or polymer mixture prepared via aqueous emulsion polymerization and comprising from 0.01 to 30% by weight of a component of a redox initiator system mainly absorbed in the polymer particles or on the polymer particles,
component B
from 50 to 90% by weight, based on the entirety of polymers and monomers (A and B), of at least one ethylenically unsaturated monomer,
component C
from 0.01 to 5% by weight, based on the entirety of polymers and monomers (A and B), of at least one component of a redox initiator system which forms the partner of the initiator component absorbed in the particles of A, (component C) and
component D
from 0 to 800% by weight, based on the entirety of polymers and monomers (A and B), of fillers, pigments, and other auxiliaries.

5. The composition as claimed in claim 1, wherein component A comprises
a) from 5 to 100% by weight, based on component A, of a monoifunctional (meth)acrylate monomer whose water-solubility is <2% by weight at 20° C.
b) from 0 to 70% by weight, based on component A, of a monomer copolymerizable with the (meth)acrylate monomer
c) from 0 to 5% by weight, based on component A, of a polyunsaturated compound, and
d) from 0 to 20% by weight, based on component A, of a polar monomer whose water-solubility is >2% by weight at 20° C.,
and component B comprises 2-(2-(2-ethoxyethoxy)-ethoxy)ethyl methacrylate, tetrahydrofuryl methacrylate or 1,4-butanediol dimethacrylate, and that component C comprises, as peroxide, dibenzoyl peroxide or dilauryl peroxide, and comprises, as accelerator component, N,N-dimethyl-p-toluidine or N,N-bis(2-hydroxyethyl)-p-toluidine.

6. An adhesive comprising the composition as claimed in claim 1.

7. A casting resin comprising the composition as claimed in claim 1.

8. A floor coating comprising the composition as claimed in claim 1.

9. A reactive comprising the composition as claimed in claim 1.

10. A dental composition comprising the composition as claimed in claim 1.

11. A sealing composition comprising the composition as claimed in claim 1.
